(19) United States
(12) Patent Application Publication
(10) Pub. No.: US 2010/0063966 A1
(43) Pub. Date: Mar. 11, 2010

(54) METHOD FOR FAST DE-DUPLICATION OF A SET OF DOCUMENTS OR A SET OF DATA CONTAINED IN A FILE

(75) Inventors: Julien Lemoine, Bezons (FR); Jean-Francois Marcotorchino, Paris (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly sur Seine (FR)

(21) Appl. No.: 12/296,327

(22) PCT Filed: Apr. 6, 2007
(86) PCT No.: PCT/EP2007/053435

§ 371 Date: Nov. 23, 2009

(30) Foreign Application Priority Data
Apr. 7, 2006 (FR) 06/03107

(51) Int. Cl. G06F 17/30

(52) U.S. Cl. 707/728; 707/E17.014

(57) ABSTRACT

The invention relates to a method for comparing a textual document with an existing document base. An identifier Ii is allocated to this new document Di. The document is divided into blocks Pij, such as sentences. A “unique” key Eij is associated with each sentence Pij, then searching for this key Eij in a finite state machine in order to determine which are the documents of the document base that contain the sentence Pij. A similarity is calculated between the elements of the existing database and the dataset formed by the sentences Pij. The set of the old documents contained in the existing database is determined that contain at least a fixed percentage X % of sentences of the document to be compared.

### CROSS-REFERENCE TO RELATED APPLICATIONS

The present Application is based on International Application No. PCT/EP2007/053435, filed on Apr. 6, 2007, which in turn corresponds to French Application No. 06/03107 filed on Apr. 7, 2006, and priority is hereby claimed under 35 USC §119 based on these applications. Each of these applications are hereby incorporated by reference in their entirety into the present application.

### FIELD OF THE INVENTION

The present invention relates notably to a method for fast de-duplication of a set of documents contained in a database. It also applies to a dataset contained in a file. These data may be of any type, such as multimedia data, digital data, etc. Notably it forms part of the techniques for is automatic processing of textual information and may be used in document flow processing systems.

### DESCRIPTION OF THE PRIOR ART

The technical problem posed is to be capable of finding identical documents or data with a certain percentage of resemblance in a database or in a file of great size. For example, in the case of a large textual database, this problem is divided into two subproblems:

1) in an existing document base, it is necessary to find all the similar documents, with a degree of similarity fixed by the user,
2) for a document to be inserted into a database, the user must be capable of finding all the similar documents (with a fixed degree of similarity) amongst all the documents forming the history. For example, in a document flow, comparing a new document with the oldest documents in order to detect whether or not there is a repeat of the information.
This process is necessary in every textual processing system because the duplicated documents cause a considerable “bias” in all the future analyses, for example automatic classification, contingency tables, OLAP (On Line Analytical Process) cross references. “Bias” may be understood in the present invention as an overstated “weight” given to the texts in question, to the level of importance of a thematic element to which these texts may refer or vice versa, an over-representation of their descriptive vocabularies in the universe of the global vocabulary describing the “corpus”.

There are methods called naïve methods which consist in comparing all the documents in pairs and applying thereto a measure of similarity in order to detect whether or not there is a copy. These methods require very considerable computing powers (since they have a number of iterations proportional to N²). Therefore, a base of 10 000 documents requires 100 million comparisons making these approaches industrially and is operationally unusable.

The prior art discloses various methods of de-duplication operating on relational databases, amongst which it is possible to cite the two patent applications: US 2004 0220955 Information Processing System And Method, by Kevin MCKEE and US 2005 0182780 by George H. FORMAN et al.

Patent application US 2004 0039933 discloses a method of de-duplication with a hash function MD5. Such an approach is not however efficient. Specifically, all that is required is a simple space also present in one of the compared documents for the latter to be considered different from the documents of the base. In addition, it is not explained how to find a key fast amongst a large list of keys.

With respect to the approaches using a knowledge base, they operate only on the language of the base and depend on the richness of the latter. These methods will give approximate and even inaccurate results if the base is not complete or if it does not take into account the vocabulary specific to a specialism. These approaches transfer all the complexity of the problem to the knowledge base and require one base per language.

Most of the de-duplication solutions currently used compare only a few criteria such as the source, the date, the author, the title, etc.

Hitherto no fast, unsupervised method has existed taking account of the entirety of the document and making it possible to define a percentage resemblance between the document to be inserted and the documents already present in the database. “Unsupervised” means that the method does not have elemental knowledge on the context associated with the de-w duplication problem to be processed.

### SUMMARY OF THE INVENTION

The invention relates to a method for comparing a dataset with the content of an existing data file, characterized in that it comprises at least the following steps:
allocating an identifier Ii to the dataset Di,
dividing the dataset into several blocks Bij,
associating with each block Bij, a “unique” key Eij, then searching for the key Eij in a finite state machine in order to determine which are the elements of the data file that contain this block,
calculating a similarity between the elements of the data file and the new dataset formed by the blocks Bij,
determining all the elements of the data file that contain at least a fixed percentage of blocks of the new dataset.

According to another variant, the invention relates to a method for comparing a textual document with an existing document base, characterized in that it comprises at least the following steps:
allocating an identifier Ii to this new document Di,
dividing the document into blocks Pij, such as sentences,
associating a “unique” key Eij with each sentence Pij, then searching for this key Eij in a finite state machine in order to determine which are the documents of the document base that contain the sentence Pij,
calculating a similarity between the elements of the existing database and the dataset formed by the sentences Pij,
determining the set of the old documents contained in the existing database that contain at least a fixed percentage X % of sentences of the document to be compared,
deciding on the integration of the document Di into the existing document base depending on the degree of similarity that it has with the other documents of the existing base.

It is possible to compare an existing document in a database with is the other documents in the same database.

It is also possible to compare a document to be inserted into an existing database.

The analysis of a document may comprise at least the following steps:
deleting all the insignificant characters from the sentence,
calculating the key associated with this sentence containing only the significant characters using a hash algorithm,
retrieving the integer associated with the key, in a finite state and deterministic machine, the machine returns an integer i, in the position i there is the set of indices of the sentences of the documents having the analyzed sentence, i corresponds to an index in a vector V,
if the sentence does not exist in the document, adding a new sentence identifier marked j, adding the index of the document being processed into the vector V in the position j and ignoring the step of updating the counters,
updating the list of counters of the identified sentences in the old documents, adding the index of the current document in the position i of the vector V in order to carry out the analyses of other documents.

The invention also relates to a device for comparing a dataset with to the content of an initial database, characterized in that it comprises a processor capable of executing the steps of the method according to claims 1 to 5, in determining a degree of similarity of the analyzed document with the documents present in the initial base and an output generating a decision to integrate the analyzed document into the initial base depending on its degree of similarity.

The present invention notably offers the following advantages:
an automatic method that is based on the theory of state machines, notably of finite state and deterministic machines and the techniques of calculating the hashing usually ensuring the integrity of the files (the MD5, SHA1, SHA256, RIPEMD160, TIGER, SHA384, SHA512, etc. algorithms).
a complexity of search that does not depend on the number of documents already existing in the database, due to the use of the theory of state machines.
a reduced memory occupancy, even for very large databases, thanks to the hashing techniques.
it offers the advantage of being independent of a source of knowledge which allows it to operate on any type of textual document.
The possibility of:
   taking account of a degree of resemblance between the documents corresponding to the percentage of sentences that two documents share,
   calculating the percentage resemblance between a document and an entire document base. It is therefore possible to know which is the percentage of repeat in a new document relative to a stock representing the prior art (patents, scientific articles, etc.),
the comparison of the programmable documents; it is possible for example to ignore the dates so as not to detect as different an identical document published on two different dates; the spaces, the punctuation will be considered to be insignificant during the is comparison,
the possible use on large textual databases; several millions of documents.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same referenced numeral designations represent like elements throughout and wherein:

FIG. 1, an application of the method in order to detect the partially or completely duplicated documents in a textual database,

FIG. 2, the use of the method to detect whether a new document contains a part or the totality of the documents contained in a textual database,

FIG. 3, an example of document analysis according to the method,

FIG. 4, an example of analysis of a sentence in a document using the method according to the invention,

FIG. 5, an example of a device making it possible to apply the method according to the invention.

### DESCRIPTION OF THE PREFERRED EMBODIMENTS

In order to ensure that the principle of the invention is better understood, the following example relates to the fast searching for documents that may be duplicated in a database.

It may be used for textual document bases in stock or flow mode.

The method may extend, without departing from the context of the invention, to any data or dataset contained in a file.

Generally, the method according to the invention may be used to solve at least one or both of the problems cited below:

1) comparing the duplicates on a fixed set of documents or data, making it possible for example to culminate in a new base with no duplicates or simply to discover the repeats of documents,
2) comparing a new document or a dataset with an existing base, in order to determine whether this document or these data are not already present in the base.

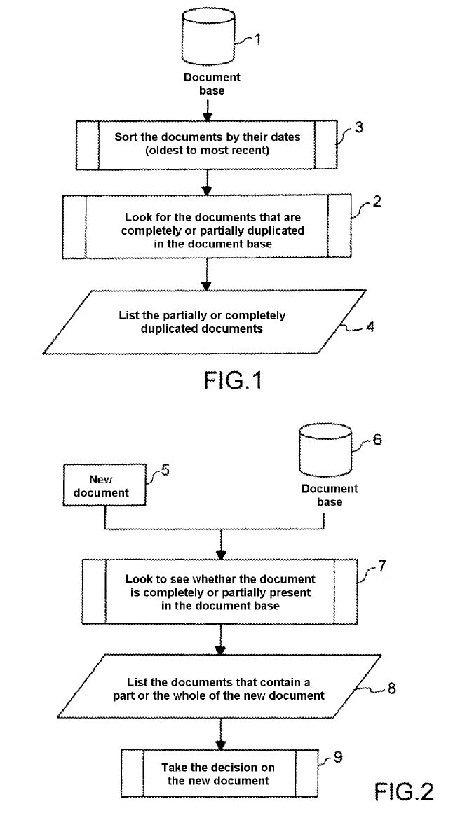

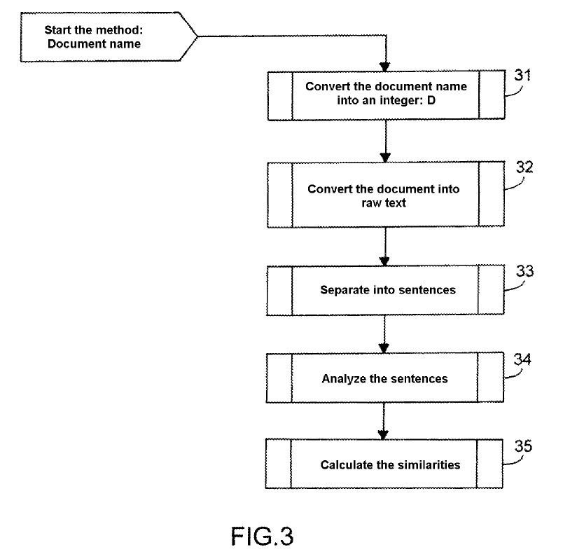

FIG. 1 schematizes overall the steps used to determine, from a document base 1, which are the partially or completely duplicated documents. The method verifies, 2, whether a document contained in the base is fully or partially present in the document base, by applying the steps described in FIG. 3, for example.

For the method to be capable of determining which document duplicates the other, the documents present in the database are sorted 3. For example, a sort by date is used, from the oldest to the most recent, in order to consider that the oldest documents serve as references. The sort may also be carried out on other criteria depending on the document base. Any sorting method known to those skilled in the art may be used.

The choice of the sort will have an influence only on the order of the relation that the method will detect (a document A repeats a document B or a document B repeats a document A).

Once the documents are sorted, it remains to run through the documents, for example, from the oldest to the most recent and subject them one by one to the steps of the method illustrated by FIG. 3.

The method produces, 4, the list of partially or completely duplicated documents. This list is in the form of a file which may be used subsequently by a decision-making program: should the documents be retained in the base? or else, this file may be used by a program for analyzing in greater depth the degree of resemblance of the documents contained in this file with the documents present in the database.

FIG. 2 represents an exemplary application of the method making it possible to compare a new document, 5, to be inserted into a database, with the documents already present in a database 6. The database, for example, has been analyzed by applying the steps described in FIG. 1.

The method analyzes the new document in order to determine whether it contains a part or all of the existing documents, 7. To carry out this analysis, the method applies the steps described in FIG. 3.

The method determines, 8, the list of documents that contain a part or the totality of the new document. Then it executes, 9, a decision-making step on the new document relating to whether or not it should be preserved in the base.

FIG. 3 describes various steps used by the method in order to process a document already present in a database or a new document to be added to this base, as has been explained in FIGS. 1 and 2.

To a document to be processed Di, the method associates an identifier Ii, for example, a unique integer 31. This identifier will remain the same throughout the analysis. For example, a counter beginning at zero will be used that is incremented with each new document. This counter serves as an index in a vector T which contains the number of sentences in the document.

The document is then converted, 32, into raw text (for example in the ASCII, Unicode, etc. format), which has the effect of deleting the formatting information of the source document in order to retain only the text or the useful data.

Once this conversion has been done, the process carries out a division of the textual document into a set of sentences Pij, 33.

This division may be carried out by a transducer for the recognition of the ends of sentences, such as that of the Unitex project that can be accessed via the Internet address http://www.-igm.univ-mlv.fr/˜unitex/ or by any other type of sentence detection.

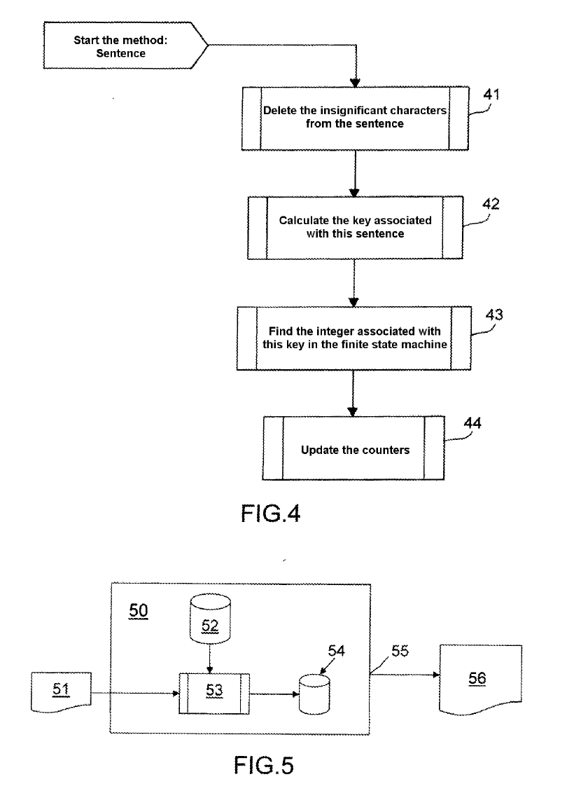

On each of the sentences of the document, the method carries out, 34, an analysis of the sentences that is described in detail in FIG. 4

At the end of the sentence analysis, the method calculates the similarities of the document will all the old documents in the base 35.

For this, the ratio between the number of sentences detected as being identical between an old and a new document divided by the number of sentences in this old document (contained in the vector T) is used, for example.

It is not necessary to calculate this ratio for all the old documents in the base. It is possible to calculate it only for the documents having at least one sentence in common with the new document.

The method can store the list of documents having at least one sentence in common by means of the “red and black tree” algorithmic is structure (described, for example, in the book “Introduction to algorithms” by T. Cormen, C. Leiserson, R. Rivest, chapters 13 and 14) so as not to contain the document indices several times (for example, not to contain twice the index of a document having two sentences in common).

These similarities correspond to the percentages of sentences that the new document shares with the old documents. There is therefore as much similarity as there are old documents having at least one sentence in common with the new document.

It is therefore possible to consider as similar two documents that have in common more than X % of sentences. The threshold X will be fixed in practice by the user of the method.

FIG. 4 details an example of steps used to analyze a document relative to the documents contained in a database. The process has a sentence of the document as an input. The steps executed are, for example, as follows:
delete all the insignificant characters from the sentence, 41, for the execution of the comparison step (for example the punctuation, the spaces, the digits, etc.). The new sentence obtained contains only the significant characters, for example, the method converts “here is an example of conversion” to “hereisanexampleofconversion”.
calculate the key Eij associated with this sentence Pij containing only the significant characters, 42, by using for example a hash algorithm (such as the MD5 algorithm invented by Ronald L. Rivest, the SHA-x family such as SHA-256 and SHA-512 designed by the “National Security Agency” of the United States, RIPEMD-160 invented by H. Dobbertin, A. Bosselaers and B. Preneel.

The choice of the algorithm used will give dimension above all to is the memory occupancy necessary for the method. Specifically, the larger the key, the greater will be the memory requirements. The collisions that these algorithms may cause, that is to say two different sentences having the same key, are not a problem. Specifically, it would be necessary for the two documents to have the same conflicts on all their sentences in order to be considered similar while they were not, which is extremely improbable in practice.
retrieve the integer associated with the key, 43, in a finite state and deterministic machine. This notably makes it possible to have a search whose complexity is independent of the number of sentences in the state machine. Let i be the integer returned by the state machine, i corresponds to the index in a vector V.
This vector V contains the position i, all the indices of the documents having the analyzed sentence. If the sentence does not exist in the state machine, it is added with a new sentence identifier that will be marked j, the index of the document being processed is added in the vector V in the position j and step 44 is ignored. In other words, the table V makes it possible to establish, for each sentence, the link between the latter and the documents that contain it.
update the list of counters of the sentences identified in the old documents, 44. These counters indicate, for each old document, the number of sentences currently identified as being in common with the new document. The counters are set to zero at the beginning of the to analysis of a document and all the counters associated with the documents containing the sentence being analyzed will be incremented by “1” (that is to say the list of documents found with the index i of the vector V). Specifically, these documents contain the sentence which the method is currently analyzing. It is therefore is necessary to update the number of sentences that have been found that are identical with the document being analyzed or substantially identical.

Finally, before moving onto the next step (analysis of a new document for example), the method adds the index of the current document to the position i of the vector V for the next document analyses. Because the current document contains the sentence “i”, it is necessary to add it to the table V at the index i in order to establish the correspondence between the sentence and the document.

After the method, the user has several counters, each counter Ci being associated with a document of the initial base and containing a number that corresponds to the number of sentences of the analyzed document that have appeared as being identical to the sentences present in a document of the initial base. The user has for example the following links: document D1-→counter C1=number of sentences of the document to be analyzed that are identical to the sentences contained in the document of the initial base.

The user defines a threshold of resemblance X fixed depending on the application, in order to decide whether an analyzed document should be considered as a duplicate of the documents forming the initial database.

If the analyzed document is considered not to be identical or substantially identical (with a given degree of similarity) to a document existing in the initial database, then it is added to the database.

Otherwise (the analyzed document is considered to be already present in the database), then it is possible either to delete it, or send it to a to method for a more detailed analysis of its content.

The steps of the method described above may be used for the following applications:
The de-duplication of documents in a flow or a stock of documents for the purpose of improving the quality of the analyses of these documents.
The identification of repeats of information when the documents are identical and only the source changes (one source has copied it from another).
The identification of a repeat of a part of a document (for example a document that includes a copy/paste of a part of another document).
The identification of documents being only the integration of earlier documents in a document flow (for example “roundup of information” dispatches by AFP which contain all the dispatches of the day).

This method may be used for example to monitor the changes of agency dispatches. It is routine to see on a particular subject several modifications between the first dispatch and the final version. In addition, the dispatches very frequently repeat the content of previous dispatches but without referring to them. The system makes it possible to automatically detect that the dispatch repeats the totality or a part of previous dispatches and the present dispatches as links in addition to the latter.

FIG. 6 represents an exemplary system comprising, for example, an analysis server 50 receiving a document 51 to be analyzed. The server comprises a document base 52, connected to a processor 53 on which the method according to the invention is executed. The output from the processor generates a subset 54 of the base containing the documents repeated by the document to be analyzed. The file containing all the to documents that are repeated and the percentage repeat is used, for example, to decide on adding the documents or deleting them if the user is searching for duplicates in an existing database. The file may also be injected into a more detailed analysis program.

An output 55 from the analysis server generates a document 56 is enriched with links to the repeated documents which therefore make it possible to have access to the content of the document.

The input, instead of being a document to be analyzed, may also take the shape of an acquisition of conventional documents (http, email, etc.) and the output may be via a screen or a printer.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for comparing a dataset with the content of an existing data file, comprising the following steps:
allocating an identifier Ii to the dataset Di,
dividing the dataset into several blocks Bij,
associating with each block Bij, a unique key Eij, then searching for the key Eij in a finite state machine in order to determine which are the elements of the data file that contain this block,
calculating a similarity between the elements of the data file and the new dataset formed by the blocks Bij, and
determining all the elements of the data file that contain at least a fixed percentage of blocks of the new dataset.

2. A method for comparing a textual document with an existing document base, comprising at least the following steps:
allocating an identifier Ii to this new document Di,
dividing the document into blocks Pij, such as sentences,
associating a unique key Eij with each sentence Pij, then searching 4 for this key Eij in a finite state machine in order to determine which are the documents of the document base that contain the sentence Pij,
calculating a similarity between the elements of the existing database and the dataset formed by the sentences Pij,
determining the set of the old documents contained in the existing database that
contain at least a fixed percentage X % of sentences of the document to be compared, and
deciding on the integration of the document Di into the existing document base depending on the degree of similarity that it has with the other documents of the existing base.

3. The method as claimed in claim 2, wherein a document that already exists in a database is compared with the other documents contained in the same database.

4. The method as claimed in claim 2, wherein a document to be inserted into an existing database is compared.

5. The method as claimed in claim 2, wherein the analysis of a document includes the following steps:
deleting all the insignificant characters from the sentence,
calculating the key associated with this sentence containing only the significant characters using a hash algorithm,
retrieving the integer associated with the key, in a finite state and deterministic machine, the machine returns an integer i, in the position i there is the set of indices of the sentences of the documents having the analyzed sentence, i corresponds to an index in a vector V,
if the sentence does not exist in the document, adding a new sentence identifier marked j, adding the index of the document being processed into the vector V in the position j and ignoring the step,
updating the list of counters of sentences identified in the old documents,
adding the index of the current document to the position i of the vector V in order to carry out the analyses of other documents.

6. A device for comparing a dataset with the content of an initial database, comprising a processor capable of executing the steps of the method according to claim 1, in determining a degree of similarity of the analyzed document with the documents present in the initial base and an output generating a decision to integrate the analyzed document into the initial base depending on its degree of similarity.

7. A device for comparing a database with the content of an initial database, comprising a processor capable of executing the steps of the method according to claim 2, in determining a degree of similarity of the analyzed document with the documents present in the initial base and an output generating a decision to integrated the analyzed document into the initial base depending on its degree of similarity.
